(19) United States
(12) Patent Application Publication
(10) Pub. No.: US 2011/0238553 A1
(43) Pub. Date: Sep. 29, 2011

(54) ELECTRONIC ACCOUNT-TO-ACCOUNT FUNDS TRANSFER

(76) Inventors: Ashwin Raj, Foster City, CA (US); John Richard Tullis, San Francisco, CA (US); Shilpak Mahadkar, Oakland, CA (US); Rupa Vazirani, Menlo Park, CA (US)

(21) Appl. No.: 12/792,275

(22) Filed: Jun. 2, 2010

Related U.S. Application Data
(60) Provisional application No. 61/318,194, filed on Mar. 26, 2010.

(51) Int. Cl. G06Q 40/00; G06Q 20/00; G06Q 10/00

(52) U.S. Cl. 705/37; 705/41

(57) ABSTRACT

Funds are electronically transferred between a provider and a beneficiary. A provider accountholder accesses a funds transfer system to communicate with a host. The provider accountholder sends the host information sufficient to process the electronic funds transfer including designating transfer conditions to be satisfied prior to remittance of the funds from a provider account to a beneficiary account. The host receives the funds transfer request from the provider accountholder, receives authorization of the funds transfer from the issuer of the provider account, and, prior to remitting the funds, determines if the transfer conditions are satisfied. In some implementations, the funds are suspended in the provider account or transferred to a temporary account before the remittance. A system is disclosed for generating a payment card for any beneficiary account type, where the funds transfers terminates in a new account opening, followed by funding of that new account.

### CROSS-REFERENCE TO RELATED APPLICATIONS

This application claims priority to, and the benefit of, U.S. Application Ser. No. 61/318,194, filed on Mar. 26, 2010, titled “Electronic Account-To-Account Funds Transfer,” which is incorporated herein by reference.

### FIELD

Implementations generally relate to processing a transfer of funds, and more particularly, to electronically transferring funds from a provider account to a beneficiary account.

### BACKGROUND

Point of sale payment transactions between consumer and merchants is well known. The transactions or “purchases” may be sales, leases, rentals, assignments, or licenses of the resources, where the consumer exchanges some form of currency (e.g., money or “points” in a loyalty program) with the merchant for the resources (e.g., goods or services) of the merchant. The transactions may be cashless such that currency is transferred from the accounts of consumers to the respective merchants. Examples of these consumer accounts include accounts that are issued to the consumers by financial institutions (“issuers”) within a transaction processing system.

Unlike payment transactions with merchants, consumers do not have similarly convenient options to electronically transfer funds to a beneficiary such as to a person or entity that may not have an established account in which to deposit the funds. For example, a consumer may want to transfer funds to an unbanked friend, an underbanked relative, or to a retailer without having to transfer the funds to an established account of the retailer. Here, the consumer would have to send a check or use conventional electronic funds transfer systems, such as a money order. For example, the consumer may have to get a money order from a bank by physically going to a money transfer agent, requesting the transfer of the money to a partnering transfer agent in the vicinity of the friend or relative, and asking the friend or relative to go to the partnering transfer agent to physically pick up the money. Moreover, if the money is converted into a different currency, the value of the money transferred may depreciate by the time the friend or relative goes to pick up the money.

On an international scale, remittance of funds across geographical borders is further complicated by the potential for abuse, such as money laundering or terrorist financing. Remittance can be difficult to track, thus making it a particularly attractive means to illicitly traffic funds.

Accordingly, it would be an advantage to provide solutions for electronically transferring funds.

### SUMMARY

In one implementation, a host in a transaction processing system receives a transfer request from a provider to electronically transfer funds from a provider account to a beneficiary account of a beneficiary. The host sends an authorization request to the issuer associated with the provider account and receives a response back from the issuer authorizing the funds transfer. The host sends to the provider a transfer code associated with the transferring of the funds that is to be included in a load request. The provider sends the transfer code to the beneficiary, for the beneficiary to include in the load request, which represents a request to load the funds into the beneficiary account. The host receives, from the beneficiary, the load request including the transfer code sent to the beneficiary. Prior to remitting the funds, the host determines if a transfer condition has been satisfied, such as by comparing the transfer code received in the load request with the transfer code sent to the provider, for example. In another example, the transfer condition may be that an identifier of the provider, the beneficiary, or their respective accounts is not on a money laundering watch list. When the transfer condition is satisfied, the host sends a remittance request to the issuer to transfer the funds from the provider account and the host sends data to the beneficiary issuer sufficient for the beneficiary issuer to facilitate the distribution of a personalized card associated with the beneficiary account. As such, a system opens any kind of payment card for any beneficiary account type, where the funds transfers terminates in a new beneficiary account opening, followed by funding of that new beneficiary account.

In another implementation, a server apparatus includes a server and a server readable medium. The server communicates with both an Internet network and a proprietary transaction processing network, including a provider issuer computing device (PICD) of an issuer associated with a provider account and a beneficiary issuer computing device (BICP) associated with the beneficiary issuer. The server readable medium includes stored server readable code that is executable by a processor apparatus. The server receives, via the transaction processing network, an authorization approval to transfer funds from a provider account of a provider to a beneficiary account of a beneficiary that is associated with a first identifier. The server receives, via the Internet, a load request from the beneficiary and a second identifier of the beneficiary. The server determines when a transfer condition is satisfied including authenticating the beneficiary by matching the first identifier with the second identifier. When the transfer condition is satisfied, the server forms a remittance request for delivery, via the transaction processing network, to the PICD. The server also forms a card generation request for delivery to the BICD via the transaction processing network for generation of a personalized card corresponding to the beneficiary account.

In yet another implementation, a machine has means for loading an account (e.g.; prepaid or another type of account) with funds. The machine receives an authorization approval from an issuer of a provider account to transfer funds from the provider account to a prepaid account that is to be activated and loaded in the future, for example, by a beneficiary. Thereafter, the machine receives an activation request and facilitates the activation of the prepaid account. The machine receives a load request to load the prepaid account and determines if the transfer conditions for the funds transfer is satisfied by, for example, matching a code received from the beneficiary with a known code for the beneficiary. When the transfer condition is satisfied, the machine sends a load request to the issuer of the provider account to transfer the funds from the provider account. As such, a system opens any kind of payment card for any beneficiary account type, where the funds transfer terminates in a new account opening, followed by funding of that new account.

### BRIEF DESCRIPTION OF THE DRAWINGS

Implementations will become more apparent from the detailed description set forth below when taken in conjunction with the drawings, in which like elements bear like reference numerals.

FIG. 1 depicts a block diagram of an exemplary funds transfer system to illustrate an exemplary environment in which an electronic account-to-account funds transfer may occur;

FIG. 2 depicts a cross functional flowchart of an exemplary method for electronic account-to-account funds transfer, which can be performed in the environment of FIG. 1;

FIG. 3 depicts an exemplary sub-method, within the method of FIG. 2, for a provider to facilitate the electronic account-to-account funds transfer;

FIGS. 4 and 5 are screen shots of respective user interfaces for facilitating an electronic account-to-account funds transfer within the environment of FIG. 1;

FIG. 6 depicts an exemplary sub-method, within the method of FIG. 2, for a beneficiary to facilitate the electronic account-to-account funds transfer;

FIGS. 7 and 8 are screen shots of respective user interfaces for facilitating an electronic account-to-account funds transfer within the environment of FIG. 1;

FIG. 9 depicts an exemplary sub-method, within the method of FIG. 2, for a host to facilitate the electronic account-to-account funds transfer; and

FIG. 10 depicts a continuation of the exemplary sub-method in FIG. 9.

### DETAILED DESCRIPTION

### Exemplary Funds Transfer System Overview

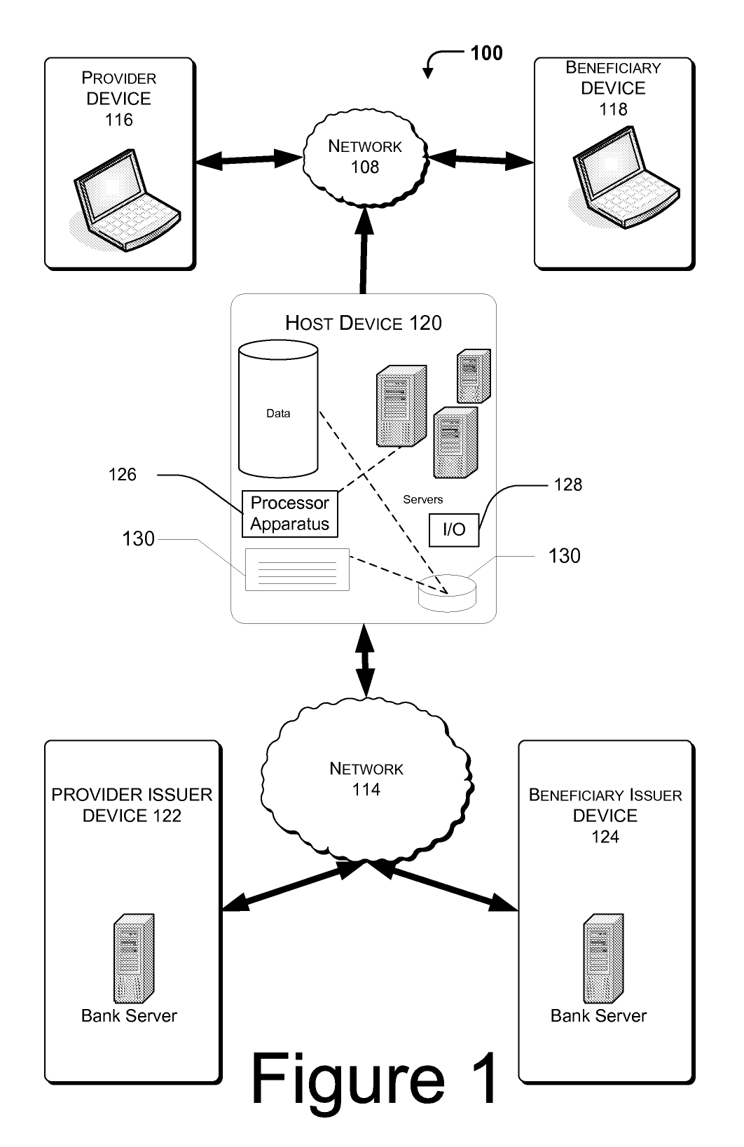

Referring to FIG. 1, an exemplary funds transfer system 100 is shown for transferring funds from a funds provider (“accountholder”) having a provider account established with the funds transfer system 100 to a funds beneficiary who may or may not have an established beneficiary account. To affect this transfer, the funds transfer system 100 includes a host device 120 that is communicatively coupled with a provider device 116, a beneficiary device 118, a provider issuer device 122 and a beneficiary issuer device 124. The host device 120 executes transaction processing algorithms for receiving a request to transfer funds from a provider, and for completing a transfer of funds, including algorithms for communicating with the provider device 116, the beneficiary device 118, and the issuer devices 122 and 124 and/or other financial institutions. The provider and beneficiary devices 116 and 118 are operated by or for the provider and beneficiary of the transfer, respectively, and the provider and beneficiary issuer devices 122 and 124 are operated by financial institutions or account “issuers”, such as banks, credit unions, savings and loan institutions, or brokerages, etc. which administer savings, checking, credit, debit, and other types of financial accounts for the provider and beneficiary, respectively.

Referring still to FIG. 1, the host device 120 can be in communication with the provider device 116 and the beneficiary device 118 through a network connection 108 (e.g., a user network, which can be a public network 108 such as the Internet), and to the account issuer devices 122 and 124 through another network (e.g., a private or proprietary network 114). Although a single provider device 116, beneficiary device 118, host device 120, provider issuer device 122, and beneficiary issuer device 124 are shown here, it will be apparent that any number of entities and corresponding devices can be part of the funds transfer system 100, and further that, while two networks 108 and 114 are shown, any number of networks could also be provided in the funds transfer system 100. Additionally, although a specific set of components are shown here, it will be apparent to those of ordinary skill in the art that not all of the components shown here will be necessary in all funds transfer transactions, and further, that in some applications, a single network could also be used.

The provider device 116, beneficiary device 118, host device 120, provider issuer device 122, or beneficiary issuer device 124, may each be a computing device (e.g., a special purpose computer) such as a server, a mainframe computer, a mobile telephone, a personal digital assistant, a personal computer, a laptop, an email enabled device, or a web enabled device, each having one or more processors (e.g., a Central Processing Unit, a Graphical Processing Unit, or a microprocessor) that executes an algorithm (e.g., software) to transfer funds by receiving data, transmitting data, storing data, or performing methods. Each device further includes input/output capabilities (e.g., a keyboard, a mouse, a stylus and touch screen, or a printer), and one or more data repositories (e.g., one or more hard disk drives, tape cartridge libraries, optical disks, or any suitable volatile or nonvolatile storage medium, storing any combination of databases, or the components thereof, in a single location or in multiple locations, or as an array such as a Direct Access Storage Device (DASD), redundant array of independent disks (RAID), virtualization device, . . . etc., structured by a database model, such as a relational model or a hierarchical model). The computing devices can also include wired and wireless communication devices which can employ various communication protocols including near field (e.g., “Blue Tooth”) and far field communication capabilities (e.g., satellite communication or communication to cellular sites of a cellular network), and which may support a number of services such as: Short Message Service (SMS) for text messaging, Multimedia Messaging Service (MMS) for transfer of photographs and videos, or electronic mail (email) access. In some applications, the computing devices can also include a cash register, a point of sale device, or a point of interaction (POI) device. Provider and beneficiary devices, in particular, can also include devices for reading magnetic strips and RFID devices. Provider and beneficiary devices can also include corresponding devices, including a payment card, a gift card, a smartcard, a smart media, a payroll card, a healthcare card, a wrist band, a machine readable medium containing account information, a keychain device, such as a SPEEDPASS® device commercially available from ExxonMobil Corporation, or a supermarket discount card, and can include a volatile or non-volatile memory to store information such as the account number, a provider name, account or other identifier.

The networks 108, 114, or other networks described in this application, may be public or private networks, and may include any of a variety of one or more suitable means for exchanging data, such as: the Internet, an intranet, an extranet, a storage area network (SAN), a wide area network (WAN), a local area network (LAN), a virtual private network, a satellite communications network, an Automatic Teller Machine (ATM) network, an interactive television network, or any combination of the foregoing. The networks may contain either or both wired or wireless connections for the transmission of signals including electrical connections, magnetic connections, or a combination thereof. Examples of these types of connections are known in the art and include: radio frequency connections, optical connections, telephone links, a Digital Subscriber Line, or a cable link. Moreover, networks may utilize any of a variety of communication protocols, such as Transmission Control Protocol/Internet Protocol (TCP/IP), for example.

In one example, the network 114 includes a private network transaction processing system that is or includes a system of the type operated by: American Express Travel Related Services Company, Inc; MasterCard International, Inc.; Discover Financial Services, Inc.; First Data Corporation; Diners Club International, LTD; Visa Inc.; and agents of the foregoing. In one particular implementation, for example, the transaction processing system is the VisaNet® system operated in part by Visa Inc., which can include one or more data centers for processing transactions, where each transaction can include up to 100 kilobytes of data or more. Accounts in the transaction processing system can include a debit account, a credit account, a charge account, a stored-value account, a demand deposit account (DDA), a prepaid account (e.g., a gift account, reloadable account, Flexible Spending Account, Healthcare Savings Account . . . etc.), or a loyalty account where points can be redeemed (e.g., 50 reward points in a loyalty program are equal to $US20 toward a purchase).

Referring again to FIG. 1, by way of example, the host device 120 is shown to include a processor 126, a readable medium, an input/output means 128 (e.g., a display or a keyboard), and a database DB 130. As described above, the processor 126 accesses executable code stored on the server readable medium, and executes one or more transaction processing algorithms for receiving a request to transfer funds from a provider to a beneficiary, and for completing a transfer of funds, including algorithms for communicating with the provider device 116, the beneficiary device 118, and the issuer devices 122 and 124 and/or other financial institutions.

To verify and transfer funds, the data stored in the DB 130 of the host device 120 may include information about the users (the provider, the beneficiary, the host, and the issuers of accounts) of the funds transfer system 100, their respective communication devices, or the user's past usage of the funds transfer system 100. The information about the users may include: a profile for the provider; a profile for the beneficiary; or data transfer capabilities of each bidirectional communication channel within the funds transfer system 100, for example. To illustrate, a user profile of the provider may include data about each of multiple provider accounts of the provider or data about past usages of each of the provider accounts to remit funds within the funds transfer system 100.

During a transaction, when requesting a transfer of funds, the provider presents a corresponding provider account identifier to the host device 120, which forms an authorization request for the issuer of the provider account that includes transaction information about the transfer from the provider to the beneficiary. The transaction information may have several data fields. For example, as is known by those of ordinary skill in the relevant art, the data fields may include: a name of the provider, the account identifier (e.g., Primary Account Number or “PAN”), an expiration date of the provider device, a Card Verification Value (CVV), a Personal Identification Number (PIN), a discretionary code of the issuer of the account, a date, a time of the transaction, a merchant identifier (e.g., merchant indicator) of the corresponding merchant, data usable to determine a location of the merchant, a Point of Interaction (POI) identifier, a total transaction amount, a Universal Product Code of the resource being purchased, a Stock Keeping Unit of the resource being purchased, a promotion code, an offer code, or a code corresponding to the financial institution associated with the provider.

To facilitate transfer of funds from the provider account to the beneficiary account, the host device 120 may send the funds transfer request as an authorized request to the provider issuer device 122 in order to transfer funds out of the provider account into the beneficiary account. The provider issuer device 122 may analyze the authorization request and form an authorization response for delivery back to the host device 120 via the network 114. The authorization response may include an authorization of the funds transfer or a decline to authorize the funds transfer. The provider issuer device 122, or the host device 120, may authorize the funds transfer after a determination that the account has sufficient funds to cover the funds transfer.

The funds can then be removed from the available balance of the provider account such that the provider no longer has access to the removed funds. When processing funds transfer, the funds can be cleared and settled and automatically transferred to the beneficiary account, after any transfer conditions specified for the transaction, discussed below, are satisfied. For example, prior to finalizing the remittance to the beneficiary account, the beneficiary may first be authenticated; the currency exchange rate may be compared with a threshold exchange rate; or the identifier of the provider, the beneficiary, or their respective accounts may be compared against data in a money laundering watch list. Moreover, if the transfer conditions are not met, then the funds may spring back so that they are transferred to a different account specified by the provider. To this end, the transfer of funds from the accountholder to the beneficiary may afford the benefits and protections associated with authorization requests, authorization responses, fraud analyses, data mining capabilities, loyalty program incentives, and funds transfer guarantees associated with payment transactions upon the accounts to merchants within the transaction processing system as known by those of ordinary skill in the art. The settlement of the transaction, for example, may include depositing an amount of the transaction settlement from a settlement house, such as a settlement bank, into a clearinghouse, such as a clearing bank. There may be intermittent steps in the foregoing process, some of which may occur simultaneously. The transaction processing system will preferably have network components suitable for scaling the number and data payload size of transactions that can be authorized, cleared and settled in both real time and batch processing. These include hardware, software, data elements, and storage network devices for the same. Thus, a typical payment transaction involves various entities to request, authorize, and fulfill processing the payment transaction.

During funds transfer transactions, the host device 120 may maintain a log or history of the transactions as they pass through the funds transfer system 100. The transaction log may be later analyzed or mined. In one implementation, the host device 120 may store the transaction information received during the processing of the transaction in the DB 130, such as: the transaction information received in the authorization request, the authorization response, or data received during the clearing and settlement process. The data corresponding to the transaction can also include information about offers, coupons, rebates, rewards, loyalty, discounts, returns, exchanges, cash-back transactions, etc. The data concerning transactions can also be stored in the DB 130, and can be data mined and used for advertising, merchant offers, account holder and merchant loyalty incentives and rewards, fraud detection and prediction, and to develop tools to demonstrate savings and efficiencies made possible by use of the transaction processing system.

### Exemplary Processes for Funds Transfer

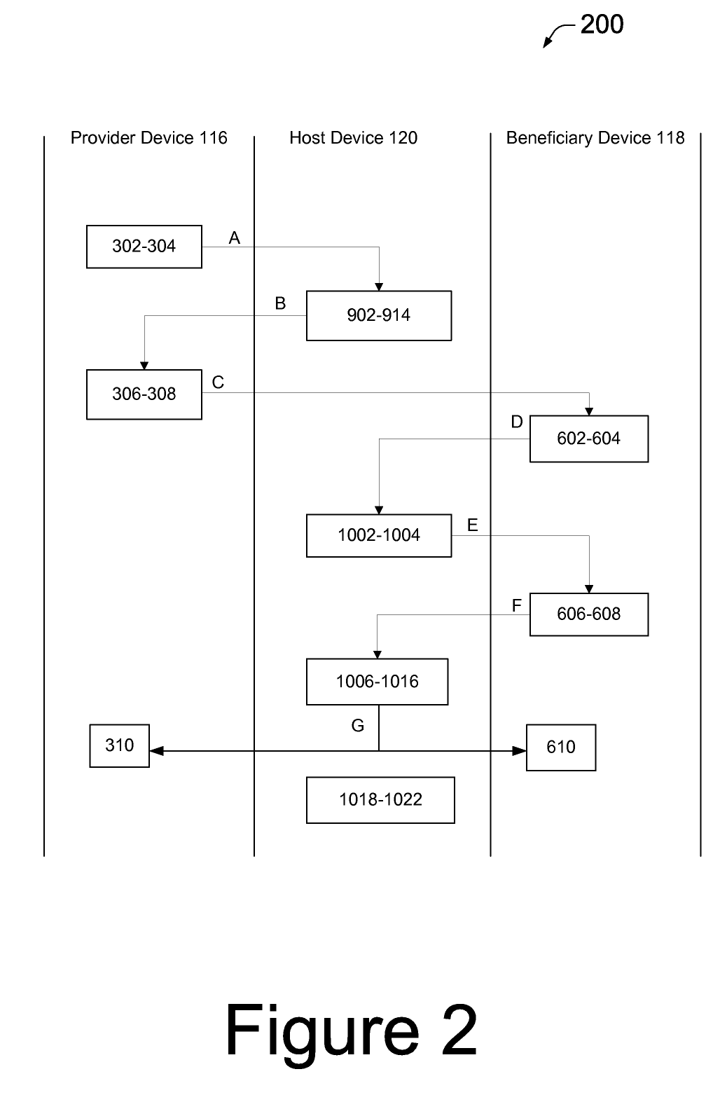

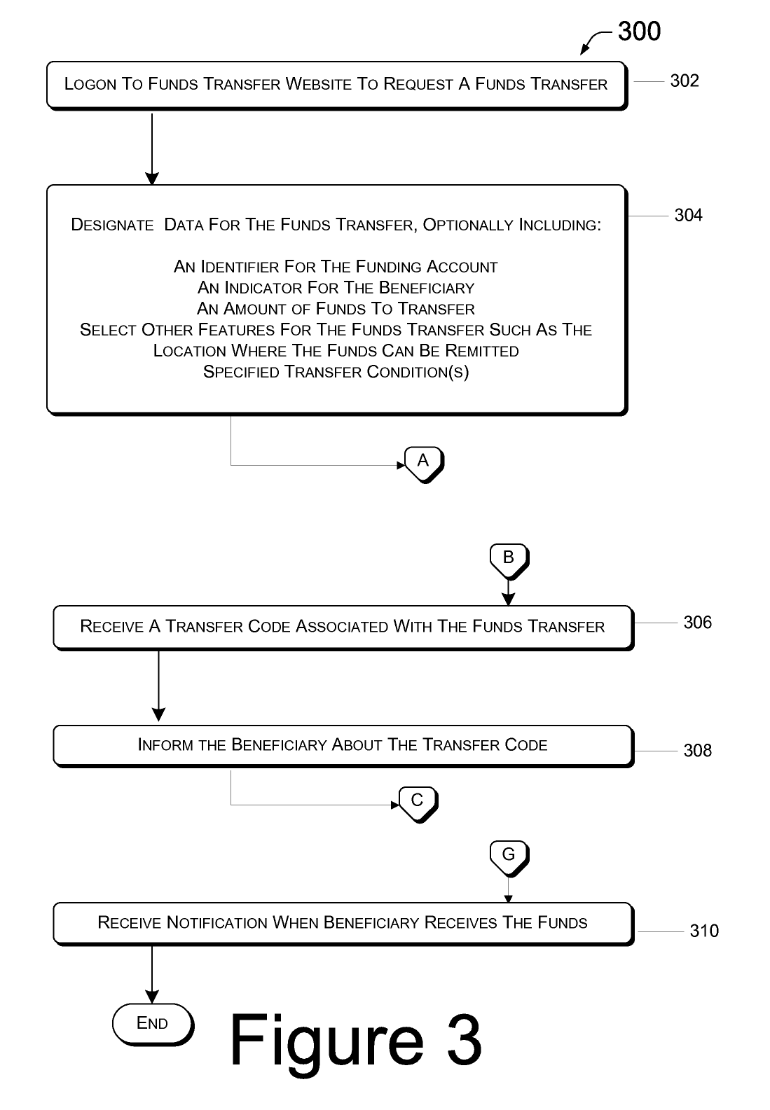

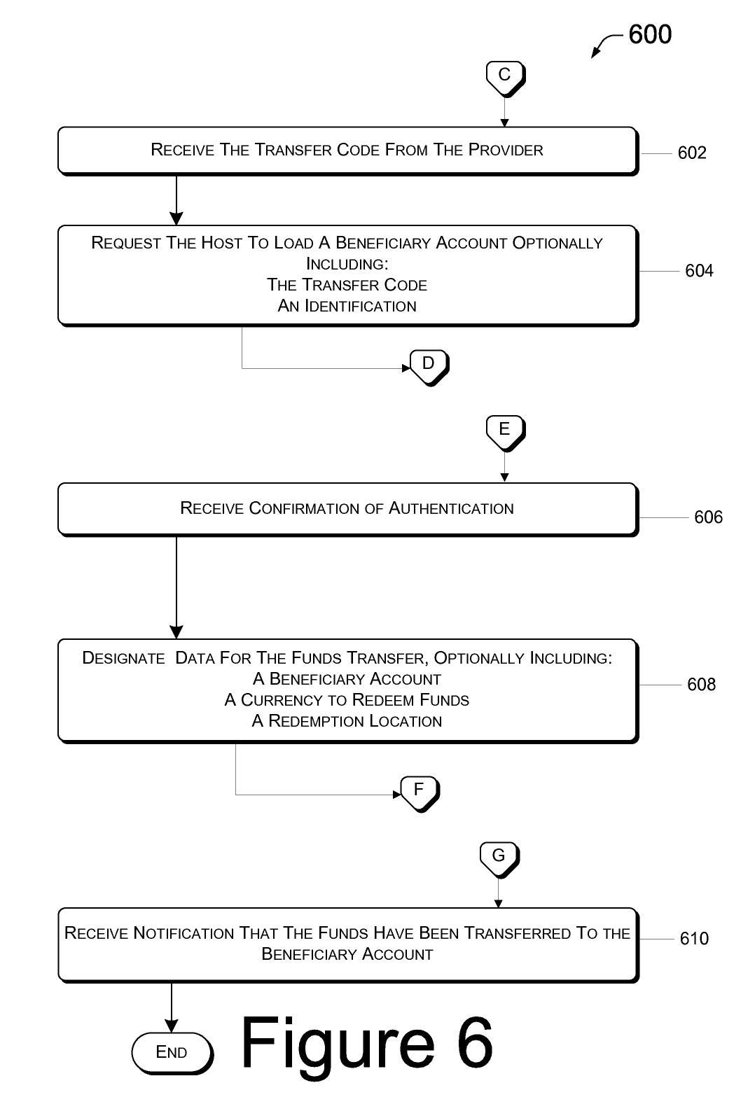

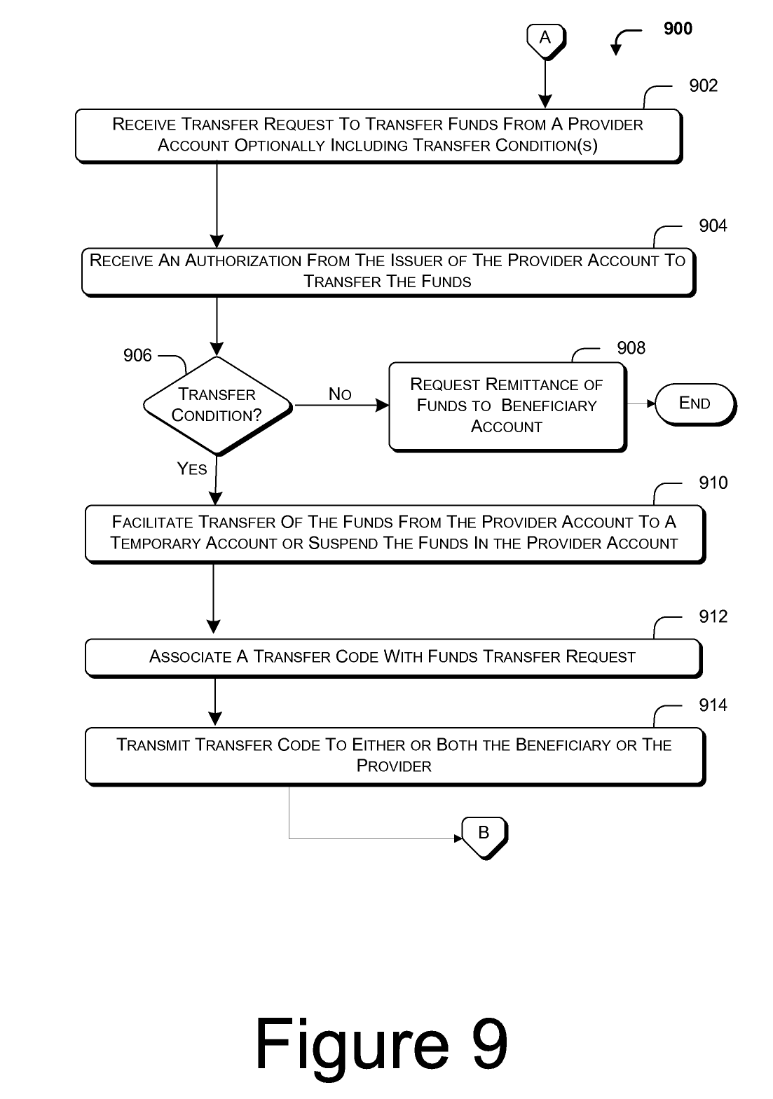

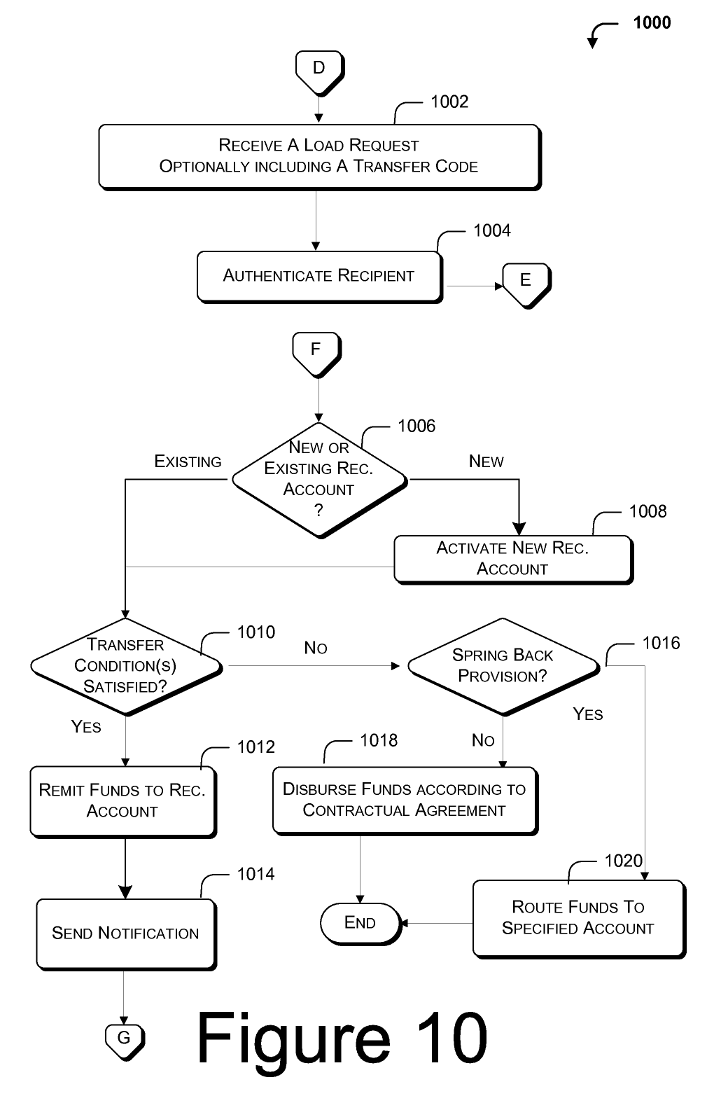

FIG. 2 shows a cross functional flowchart depicting a method 200 for electronically transferring funds from the provider account to the beneficiary. The cross functional flowchart depicts the steps that each of the provider device 116, the host device 120, and the beneficiary device 118 may implement in the method 200. The provider device 116 requests to transfer the funds from the provider account at steps 402 to 410, which are further described in sub-method 300 described in FIG. 3. The host device 120 receives the funds transfer request and transfers the funds out of the provider account at steps 902 to 914, which are further described in sub-method 900 described in FIG. 9. The beneficiary device 118 requests that the beneficiary account be loaded with the funds at the steps 602 to 608, which are further described in sub-method 600 described in FIG. 6. The host device 120, in turn, receives the load request from the beneficiary and transfers the funds to the beneficiary account at the steps 1002 to 1022, which are further described in sub-method 1000 described in FIG. 10. The cross functional flowchart also depicts the flow of information from one entity to another via off-page references A to G.

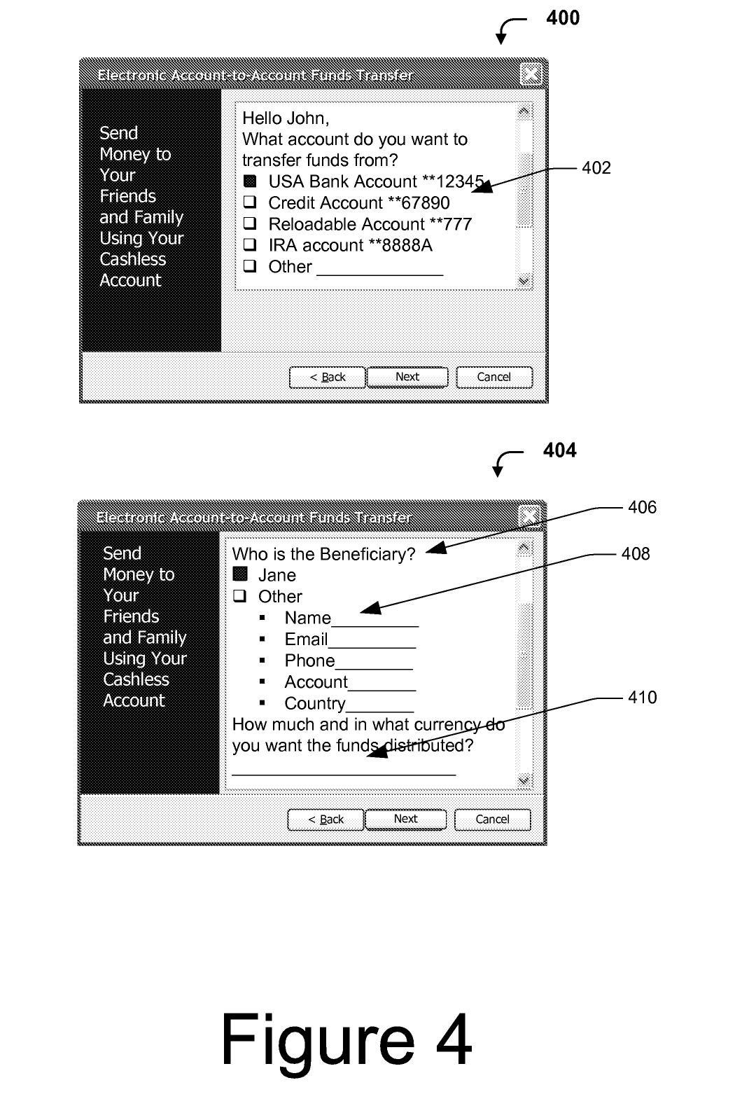

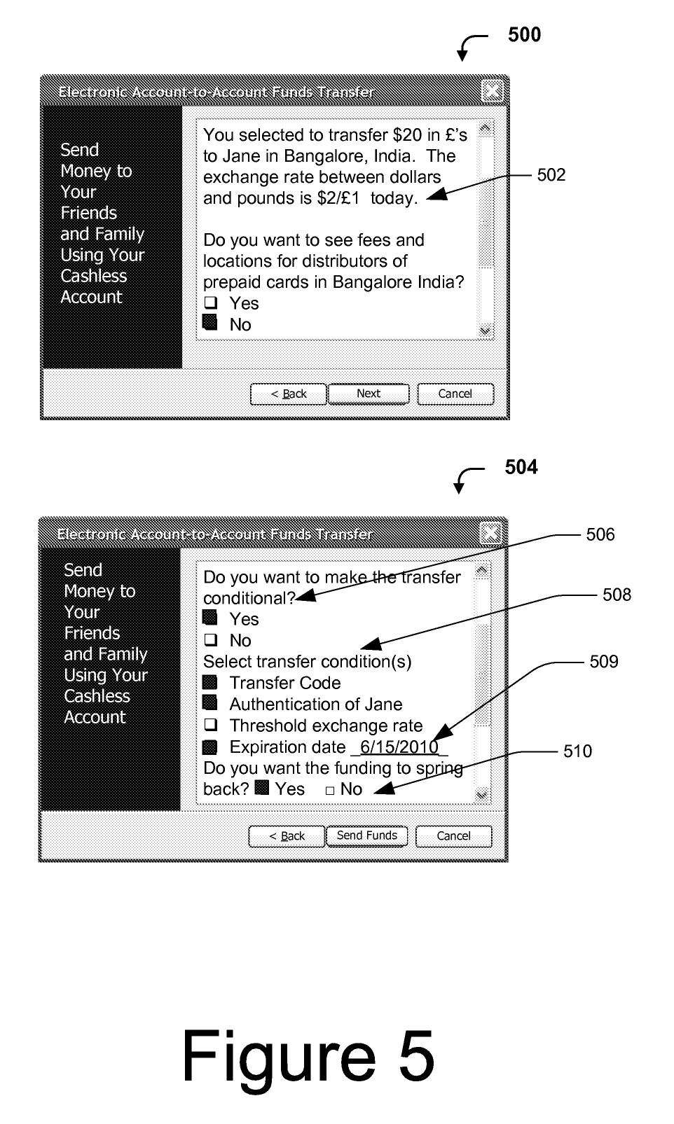

Referring to FIG. 3, a flowchart depicts an exemplary sub-method 300 for the provider to access the host device 120 to facilitate an electronic funds transfer from a provider account to the beneficiary account. FIGS. 4 and 5 depict corresponding screen shots of exemplary user interfaces 400, 404, 500, and 504 for executing the steps of sub-method 300.

At step 302, the provider uses the provider device 116 to access a web site associated with the host device 120 via the network 108. The web site is rendered through a user interface allowing the provider to designate the beneficiary and other data for the transfer of funds as shown in FIGS. 4 and 5. At step 304 of FIG. 3, the provider designates data for the funds transfer that can optionally include: an identifier for the provider account, an identifier for the beneficiary, an amount of funds to transfer, or other features for the funds transfer, such as the location where the funds can be remitted. For example, at data entry element 402 of user interface 400, the provider identifies a provider account for funding the transfer, either by entering an account number or accessing a listing of accounts issued to the provider stored in the DB 130, shown as a list at user interface 400. At data entry element 406 of user interface 404, the provider identifies the beneficiary either by designating a previously stored beneficiary, or by identifying a new beneficiary by providing, for example, one or more of a name, email, phone number, address, or account number of the beneficiary (408, FIG. 4). The provider can specify the amount of funds to be transferred, and, for example, a selected currency for the distribution (410, FIG. 4). The transferred funds can include funds having a value measurable in a domestic or foreign currency, money, tender, loyalty points, or a combination thereof, for example.

The provider may select other features for the funds transfer. For example, as depicted in user interface 500 of FIG. 5, the provider may select features such as: threshold fees that may be charged for the funds transfer or a location for a distributor of a prepaid card or other form factor associated with the beneficiary account. In addition, the provider can choose to include a message for the beneficiary (e.g. a gift, repayment for a loan, a purchase, etc.), or provide a personal message.

At step 304 of FIG. 3, the provider, the host, or other user can also designate transfer conditions, which are conditions that are to be satisfied before the funds transfer can be completed. For example, the provider may request that the host device 120 authenticate the beneficiary prior to the transfer of the funds to the beneficiary account, by requesting that the host device 120 verify a transfer code entered by the beneficiary during a load request with a known transfer code that is uniquely associated with the funds transfer. In another example, the provider may request that the funds transfer be made before a specific expiration date (data entry element 509, FIG. 5). In yet another example, the provider may elect to have the funds “spring back” to his or her designated account (e.g., the provider account or an account of another beneficiary such as a charity). The spring back of the funds may also be conditional, such that the funds spring back to the designated account after the satisfaction of the spring back condition. For example, the spring back condition may be based on the expiration date entered at data entry element 509 such that if the funds are not claimed by the beneficiary within the time specified at the data entry element 509, then the funds are to return to the available balance of the provider account and not sent to the beneficiary account.

In another implementation, the transfer condition may be a designated currency exchange rate. For example, the transfer conditions may be that the currency exchange rate between United States dollars and English pounds should be equal to or greater than $US2/£1 on the day of loading of the beneficiary account. Here, if the currency exchange rate is below $US1/£1 on the day of receipt of the loading request then the funds are not loaded. Alternatively, or in combination, the remittance can be set to automatically occur upon the satisfaction of the transfer condition. In the above example, the remittance can be set to occur on the first subsequent day that the currency exchange rate is equal to or greater than $US2/£1. Other transfer conditions are also applicable, such as specified funds transfer fee thresholds, transmission security setting of the beneficiary device 118, threshold frequency of load requests made, or other transfer conditions.

Any of the users of the funds transfer system 100 or method 200 may designate the transfer conditions for the funds transfer. For example, the host or the provider issuer may designate one of the transfer conditions to be a maximum amount of currency for the funds transfer within the method 200 (e.g., a upper threshold of $US1000). In another implementation, the transfer condition may require verification that none of the participants or accounts that are parties to a transfer are suspected or known to be involved in money laundering. This transfer can be achieved by comparing identifiers of the provider, the provider account, the beneficiary, or the beneficiary account to a money laundering watch list that delineates individuals, entities, accounts, or other identifiers that are known or expected to be associated with money laundering, or by comparison to an anti-money laundering watch list that delineates individuals, entities, or accounts that are known not to be associated with money laundering. In another example, the beneficiary issuer may designate one of the transfer conditions to be a specified currency such that the beneficiary issuer will only process funds transfers that are for a particular currency (e.g., dollars or pounds). In yet a further example, the beneficiary may designate one of the transfer conditions to be a designated beneficiary account, such that the beneficiary will not accept a funds transfer unless it is to a specified beneficiary account.

Predetermined business rules may dictate how the transfer conditions or spring back conditions are applied. For example, the provider, the beneficiary, the host, the provider issuer, or the beneficiary issuer may have previously set up the predetermined business rules that dictate an algorithm for determining whether a transfer condition is satisfied or if there is a transfer condition hierarchy (e.g., if transfer condition 1 is satisfied then transfer condition 2 need not be satisfied) such as a required sequential flow of satisfaction of transfer conditions (e.g., a chronology dictating a temporal sequence of satisfaction of the transfer condition 1 before satisfaction of transfer condition 2).

Alternatively, or in combination, the predetermined business rules may dictate a scoring system for the transfer conditions. For example, if a first transfer condition is satisfied, a score is given to the request to transfer funds. The satisfaction or dissatisfaction of a second transfer condition then augments the score. This continues until the relevant transfer conditions are analyzed. The score can be used to determine whether to proceed with or halt the funds transfer at any point throughout the funds transfer process (e.g., the method 200). For example, the host may determine a score associated with the satisfaction or dissatisfaction of the money laundering transfer condition described above. The host device 120 may transmit this score to the provider issuer device 122, which may use the score when approving or denying authorization for the funds transfer from the provider account. In another example, the host device 120 may transmit the score to the beneficiary issuer device 124, which may use the score to determine whether to approve or deny the transfer of funds to the beneficiary account. Therefore, the users of the funds transfer system 100 may dictate the transfer conditions and their application to effectuate a transfer of funds from the provider account to the beneficiary account.

Referring to FIGS. 2, 3 and 9, the provider's designated data for the funds transfer is sent to the host device 120 via off-page reference A to step 902 of sub-method 900 at FIG. 9. Here, the host device 120 effectuates the transfer of funds from the provider account.

The host device 120 submits an authorization request to the provider issuer device 122 via network 114 within the method 200 to authorize the transfer of the funds from the provider account. The provider issuer may analyze characteristics of the provider account in order to determine whether to authorize or decline the transfer of funds. For example, the provider issuer may check the available balance of the provider account, check a credit limit of the provider account, or run fraud analysis algorithms prior to determining whether to authorize the transaction. At step 904, the host device 120 receives the authorization response from the provider issuer device 122, including the determination of the provider issuer to authorize or decline the funds transfer.

At a step 906, if there are no transfer conditions on the funding, the funds are transferred (e.g., in real time), and are therefore remitted to the identified beneficiary account at step 908, where the sub-method 900 and the method 300 end. Alternatively, if the funds transfer is conditional then the sub-method 900 moves from step 906 to a step 910.

In some implementations, although the funds are not transferred into the beneficiary account until the transfer condition is satisfied, the provider no longer has access to the funds once the funds transfer is authorized by the provider issuer. Here, at step 910, the host device 120 facilitates transferring the funds from the provider account to a temporary account (e.g., escrow) or suspending the funds in the provider account until such time that the funds can be transferred to the beneficiary account or another provider designated account (“spring back” option, above, to a provider account or a charity account). For example, the authorization request sent from the host device 120 to the provider issuer device 122 may include sufficient information for the provider issuer to remove the funds from the provider account and place the funds into a separate, temporary account that is inaccessible to the provider. To illustrate, the authorization request may include the account numbers of each of the provider account and the temporary account with a request to transfer the funds from the former to the later. In another illustration, the host device 120 may send a separate transmission to the provider issuer device 122 with instructions to transfer the funds to a temporary account of the provider issuer's choosing.

Alternatively, or in combination, the host may facilitate suspending the funds in the provider account such that the funds remain in the provider account but the provider no longer has access to the funds. For example, the authorization request from the host device 120 may include sufficient information for the provider issuer to maintain the funds in the provider account but to remove the funds from the available balance of the provider account. This process is akin to funds suspension in payment transactions with merchants. In a payment transaction, an issuer may remove a purchase amount from an available balance of an account for a period of time, typically two to three days, until the merchant clears and settles the transaction. After clearing and settling of the payment transaction, the funds are removed from the account and transferred to the acquirer of the merchant. Similarly, here, the funds may be suspended in the provider account for future transfer to the beneficiary account; however, unlike the payment transaction, the release of the suspended funds is based on the satisfaction of the transfer condition or the spring back condition.

Referring back to FIG. 9, at the step 912, the host device 120 uniquely associates a transfer code with the funds transfer. In the illustrated implementation, the provider has requested the use of a transfer code to authenticate the beneficiary (entry element 508, FIG. 5). Consequently, the host device 120 may enter an alphanumeric code into the DB 130 in association with the transfer request of the provider. The host device 120 then transmits the transfer code to either or both the beneficiary or the provider devices 116 and 118, respectively. As depicted in FIG. 9, the host device 120 transmits the transfer code to the provider device 116 via the off-page reference B to step 306 of sub-method 300.

Referring back to FIG. 3, the sub-method 300 moves from step 304 to step 308, where the provider informs the beneficiary of the transfer code. In some implementations, the provider informs the beneficiary of the transfer code using a communication channel outside of the funds transfer system 100 or method 200 depicted in FIGS. 1 and 2, respectively, such as a land telephone line. The outside communication channel may be used to increase security. For example, the provider may utilize the land telephone line to call the beneficiary to verbally relay the transfer code; in this manner the provider is assured that the beneficiary is a true recipient of the transfer code by recognizing the voice of the beneficiary. Other forms of notifications known in the art are also applicable, such as the provider drafting an email or instant message including the transfer code for delivery to the beneficiary. The sub-method 300 moves from step 308 to step 602 of FIG. 6 via off-page reference C where the beneficiary receives the transfer code.

Although sub-method 300 depicts the provider receiving the transfer code to relay to the beneficiary, other implementations are also possible. For example, the host device 120 may send the transfer code to the beneficiary device 118 directly without having the provider notify the beneficiary of the transfer code. In yet another implementation, the beneficiary receives the transfer code and relays the transfer code to the provider to forward to the host device 120. To illustrate, the beneficiary may physically go to a prepaid card distributor to obtain a new prepaid card contained with a sealed envelope that also includes the transfer code. The beneficiary then informs the provider of the transfer code contained in the envelope. The provider, in turn, sends the transfer code to the host device 120 when making a request to transfer the funds (e.g., at step 306, FIG. 3) by, for example, entering the transfer code into a data entry element at a user interface. Here, the transfer of funds from the provider account to the prepaid card is not completed until the beneficiary notifies the provider of the transfer code, and the provider enters the code into the web site hosted by the host device 120 through the provider device 116.

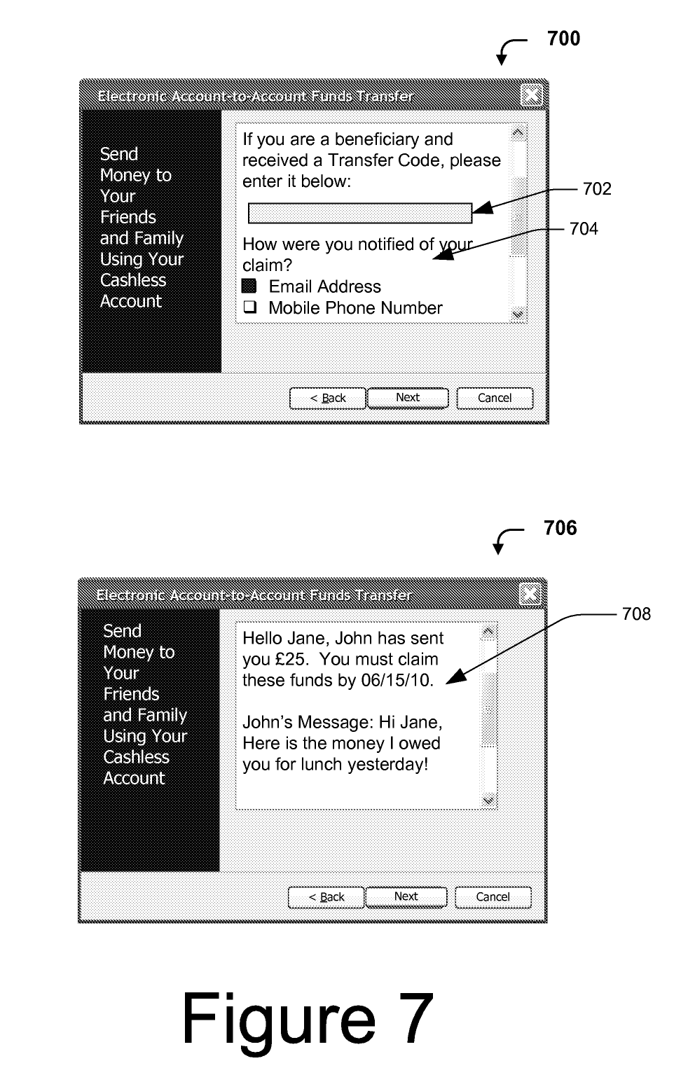

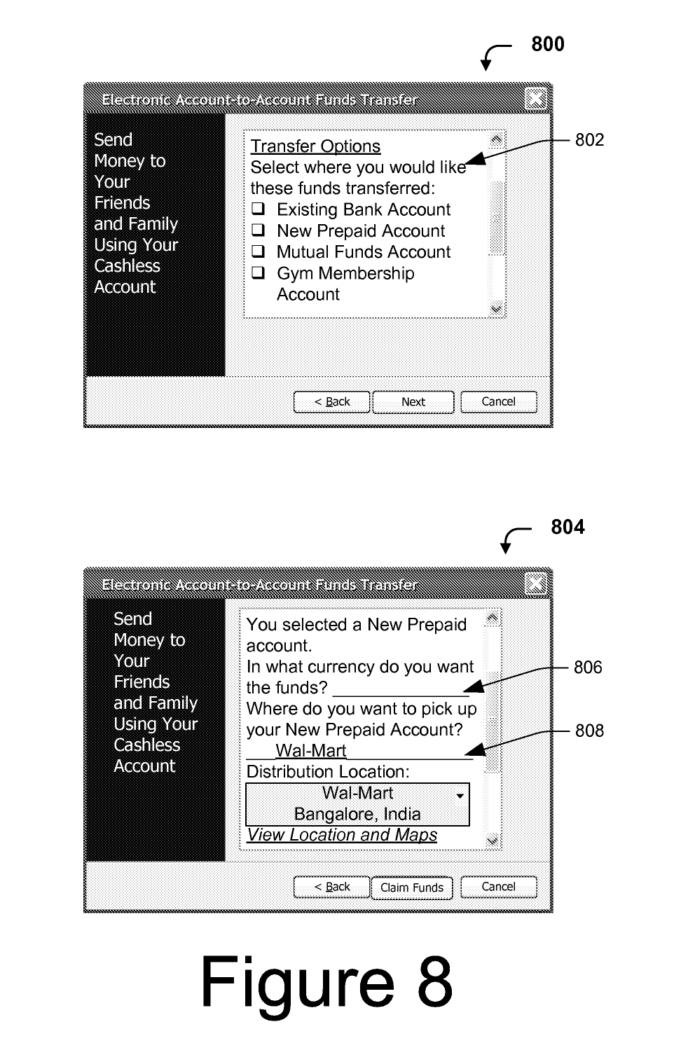

Referring now to FIGS. 6, 7, and 8, a flowchart in FIG. 6 depicts an exemplary sub-method 600 for the beneficiary to claim the funds that are to be transferred from the provider account to the beneficiary account. FIGS. 7 and 8 depict corresponding screen shots of exemplary user interfaces.

At step 602 of FIG. 6, the beneficiary receives the transfer code from the provider, via the off-page reference C (from step 308 of FIG. 3). As previously stated, the provider may have placed a telephone call to the beneficiary to verbally relay the transfer code to the beneficiary or the provider may have relayed the transfer code by other applicable means, as would be known by those of ordinary skill in the art.

To begin the process of claiming the funds, the beneficiary submits a load request to the host device 120 at step 604 by, for example, accessing the transfer web site at host device 120 through a beneficiary device 118 which, as discussed above, can be a web-enabled or other network device such as a computer, cell phone, or Personal Digital Assistant (PDA). Here, if the beneficiary was informed of the transfer code, as described above, the beneficiary also supplies the transfer code to the host device 120. For example, the beneficiary may enter the transaction code in an entry field 702 of user interface 700 for delivery to the host device 120 as part of the load request. The host device 120 may utilize the received transfer code to authenticate the beneficiary by matching the received transfer code from the beneficiary with the transfer code sent to the provider (step 306, FIG. 3). If the beneficiary was not informed of the transfer code, the beneficiary may supply others forms of identification that may facilitate authenticating the beneficiary, such as an email address, phone number, social security number, driver's license number, or any of a number of other possible personal identifiers, such as by way of a logical address selection seen at data entry field 704 of FIG. 7. Although a personal identifier and transfer code are both described, it will be apparent that either type of identifier or a combination of identifiers can be used.

Referring to FIGS. 2, 6 and 10, the beneficiary device 118 sends the funds transfer load request to the host device 120 and the sub-method 600 moves from step 604 to off-page reference D, referencing step 1002 of FIG. 10. In the depicted implementation, one of the transfer conditions for the funds transfer is the authentication of the beneficiary through the use of the transfer code. As depicted in FIG. 10, the predetermined business rules for the funds transfer have dictated that the authentication of the beneficiary (step 1004) occurs before the evaluation of the other transfer conditions (step 1010). Therefore, the host device 120 compares, at the step 1004, the transfer code received in the load request at the step 1002 to the transfer code transmitted to the provider device 116 at the step 306 to find a match. Other identifiers may be matched in place of, or in combination with, the transfer code as part of the transfer condition, such as by comparing an entered cellular telephone number or email address of the beneficiary with a known cellular telephone or email address of the beneficiary, as discussed above. For example, the beneficiary device 118 may be a web-enabled cellular telephone that submitted the load request via the Network 108. The host device 120 may authenticate the beneficiary by comparing the cellular telephone number of the beneficiary received in the load request with a cellular telephone of the beneficiary that was previously stored in the DB 130 to find a match. In another implementation, the means for authenticating the beneficiary can include a cashier checking an identification of a physically present beneficiary and submitting an authentication code back to the host device 120 such as by utilizing a POS terminal.

Referring to FIGS. 2, 6-8, and 10, after the beneficiary is authenticated, the host device 120 sends a confirmation of the authentication to the beneficiary device 118, via off-page reference E from step 1004 to step 606 of FIG. 6. To illustrate, the beneficiary may receive a summary of the provider's transfer request or a personal message depicted as element 708 at the user interface 700 of FIG. 7.

At step 608 of sub-method 600, the beneficiary designates data for the funds transfer. For example, the beneficiary may designate a currency for the redeemed funds, a location to physically redeem the funds, or the beneficiary may designate the beneficiary account. To illustrate, the beneficiary may select a currency in which to redeem the funds or a location at which to redeem, as shown at data entry elements 806 and 808, respectively, of user interface 804 in FIG. 8. The selected currency or location may be the same as or differ from a one previously selected by the provider. When the beneficiary chooses a different currency or location than that previously selected by the provider, the discrepancy may be resolved based upon business or transfer set up rules by the provider, as discussed above, by the host, or by the issuer of the provider or beneficiary accounts.

Similarly, the beneficiary may designate the beneficiary account at step 608. If the beneficiary has registered beneficiary accounts with the funds transfer system 100 or method 200, the beneficiary may select to transfer the funds to one of these existing accounts, as depicted in data entry element 802 of user interface 800 in FIG. 8. The beneficiary may also elect to transfer the funds to a new or existing prepaid account, or to other accounts that are either pre-existing in database DB 130 of the host device 120, or which are specified by the beneficiary.

Referring to FIGS. 2, 6 and 10, the beneficiary's designated data for the funds transfer is sent to the host device 120 as sub-method 600 moves from step 608 to step 1006 via off-page reference F (referencing FIG. 10). Here, the host device 120 makes an inquiry to determine whether the beneficiary account is a new or existing account. If the beneficiary account is an existing account, the sub-method 1000 moves directly from the step 1006 to the step 1010. For example, the beneficiary account may be an existing account because the beneficiary account was opened during a previous funds transfer from this or different provider using the funds transfer system 100. Alternatively, or in combination, if the load request is for a new beneficiary account, the sub-method 1000 moves from step 1006 to step 1008 where the host device 120 facilitates an activation of the new beneficiary account.

In one implementation, the host device 120 facilitates the activation of the new beneficiary account upon receiving an activation request from the beneficiary device 118. For example, the beneficiary device 118 sends an activation request to the host device 120 including an account number embossed on a newly obtained prepaid card, such as by entering the account number into a data entry field of a user interface within the website hosted by the host device 120. The host device 120, in turn, forwards the activation request to the beneficiary issuer device 124 via the network 114 (e.g., Internet or private network such as VisaNet®). The beneficiary issuer device 124 activates the beneficiary account and submits an activation confirmation back to host device 120. Other means for activation of a new beneficiary account are also applicable. For example, in some applications, the beneficiary device may be operated by a merchant. Here, the beneficiary may transmit the activation request to the host device 120 via a merchant device such as a point of sale terminal that is communicatively connected with the newly obtained prepaid card. To illustrate, the beneficiary may swipe the newly obtained prepaid card at the Point of Sale (POS) terminal of the merchant, such as a supermarket. The activation request may be transmitted from the POS terminal to merchant's financial institution, which then forwards it to the host device 120 via Network 114. After the new beneficiary account is activated, the sub-method 1000 moves from step 1008 to step 1010.

At step 1010, the host device 120 determines whether the transfer condition(s) have been satisfied. As stated previously, predetermined business rules dictate the hierarchy or sequence for satisfaction of the transfer conditions. As with the transfer condition of authenticating the beneficiary using the transfer code above, the host device 120 may compare data received in the load request with known data stored in the DB 130 to find a match at step 1010. For example, the provider may have designated that the beneficiary must request the transfer of funds by a predetermined date, depicted as Jun. 15, 2010 in data entry element 509 of FIG. 5. The host device 120 may compare the date of the load request with the predetermined date to determine if there is a match, such as whether the current date is before the predetermined date. If the match is found, the transfer condition is satisfied. In another example, the transfer condition is satisfied if a match is not found. To illustrate, the host device 120 may compare an identifier of the provider or beneficiary against a money laundering watch list to determine that the identifier is not on the watch list. If the identifier is not on the watch list, then the transfer condition is satisfied.

If the transfer condition is satisfied, the sub-method 1000 moves from the step 1010 to a step 1012 where the funds are remitted to the beneficiary account and a notification is sent to either or both the beneficiary and the provider at subsequent step 1014 (via off-page reference G to either or both step 310 of FIG. 4 and step 610 of FIG. 6). The notification can be provided, for example, by an SMS message sent to the provider's cellular telephone, by an email sent to the beneficiary device 118, by a post at a website accessible by the provider device 116 or the beneficiary device 118, or other methods of communication which will be apparent to those of skill in the art. If the transfer condition is not satisfied, the sub-method 1000 moves from the step 1010 to a step 1016.

At the step 1016, a query determines if there is a spring back provision to the funds transfer. Here, if there is a spring back provision and the spring back condition is satisfied, then the funds are routed, at step 1020, to another account specified by the provider, such as back to the provider account or another account (e.g., an account of a charity organization). Here, the host device 120 sends a spring back request to the provider issuer device 122. The provider issuer device 122 may then release the suspended funds, for example, so that the funds return to the available balance of the provider account. Alternatively, or in combination, the provider issuer device 122 may transfer the funds from the temporary account to an account of a charity organization or an account of another beneficiary.

On the other hand, if there is no spring back provision or the spring back condition is not satisfied, the funds are disbursed according to contractual agreements at a step 1018. For example, the provider issuer device 122 may be notified that the transfer condition is not satisfied, such as where the dissatisfaction is caused by the expiration date having passed. The contractual agreement may be that the funds then become the property of the provider issuer or the funds are to escheat to a government organization.

### Exemplary Processes for Funds Transfer to a Beneficiary Account Associated with a Card

In yet another implementation, the provider transfers funds to an account of the beneficiary that is associated with a card (e.g., plastic card). As described above, the provider device 116 requests to transfer the funds from the provider account to the beneficiary account. Here, however, the beneficiary may not access the funds until a card is issued to the beneficiary and activated by the beneficiary. The card may be issued, for example, by a money transfer agent or distribution partner, such as a bank or a supermarket. The distribution partner may have an automated system, such as a kiosk or Automatic Teller Machine.

The table below delineates exemplary steps that can be taken to transfers funds to an account of the beneficiary that is associated with a card.

| Step | Description |
|---|---|
| 1 | The provider device 116 uses a web browser to navigate |
| | to a website hosted by the host device 120 or access the website |
| | via the provider issuer device 122. |
| 2 | The provider device 116 requests access to the host |
| | device 120. The provider or the provider device 116 may be |
| | authenticated by the host device 120 or provider issuer device |
| | 122 as having permission to access the host device 120 for the |
| | purposes of transferring funds. |
| 3 | The provider device 116 requests funds to be transferred |
| | to the beneficiary such as by selecting the option to send funds |
| | from a main menu. |
| 4 | If the provider has multiple accounts registered for the |
| | funds transfer service, a list of enrolled accounts can be rendered |
| | on the provider device 116 such as by displaying the last 4 digits |
| | of each account number. |
| 5 | The provider device 116 sends a transmission to the host |
| | device 120 indicating the amount of funds to be transferred. |
| 6 | The provider device 116 can optionally render multiple |
| | destination options including: the beneficiary's PAN, Alias, and |
| | communication address (phone #, email), or location of money |
| | transfer agent, distribution partner, or Kiosk, for example. |
| 7 | If the provider selects to have a new account issued to the |
| | beneficiary that is loaded with the transferred funds, a list of |
| | countries where this feature is available can be rendered on the |
| | provider device 116. |
| 8a | Once the provider selects the country for the new account |
| | distribution, the provider device 116 can present a choice of |
| | distribution partners to the provider. |
| 8b | The provider can also have an option to receive |
| | information about locations (e.g., visual map) or background |
| | details (potentially the fee the beneficiary will be charged, etc.) |
| | of the distribution partners where the beneficiary can go to |
| | receive the new card associated with the beneficiary account. |
| 9 | The provider device 116 sends a transmission to the host |
| | device 120 that includes the selected distribution partner that can |
| | issue the card to the beneficiary. |
| 10 | The provider device 116 sends a transmission to the host |
| | device 120 indicating the amount of funds to be transferred and a |
| | Global Unique Identifier (GUID) of the beneficiary, such as a |
| | name of the beneficiary. |
| 12 | The provider confirms transaction details and transmits |
| | the same from the provider device 116 to the host device 120. |
| 13 | The host device 120 sends to the provider device 116 |
| | potential processing fees or Forex fees (if the Money Transfer is |
| | cross border) for conducting the funds transfer. |
| 14 | The provider device 116 sends a confirmation of the |
| | transaction request. |
| 15 | The host device 120 optionally sends data to the provider |
| | device 116 data including fees, Forex, intended beneficiary |
| | details provided by the provider, transaction claim code, or |
| | distribution partner details (w/link to locations, fee tables, etc.). |
| 16 | The host device 120 sends and authorization request to |
| | the provider issuer device 122 to authorize a funds transfer (e.g., |
| | debit) from the provider's account. |
| 17 | After the issuer authorizes the funds transfer, the host |
| | device 120 sends a confirmation to the provider device 116, such |
| | as by sending an email or by using a Short Message Service |
| | (abridged). |
| 18 | The host device 120 sends a transmission to either or both |
| | the beneficiary issuer device 124 or the distribution partner to |
| | give notice of the upcoming funds transfer; the transmission my |
| | optionally contain a unique identifier code that links this funds |
| | transfer to the beneficiary. |
| 19 | The beneficiary issuer and/or the distribution partner can |
| | optionally hold the funds in escrow pending the beneficiary's |
| | activation of the account. |
| 20 | The provider shares the claim code (shared secret) with |
| | the beneficiary via their chosen communication channel. |
| 21 | The beneficiary goes to a facility of the distribution |
| | partner to receive the card associated with the account, the |
| | facility may issue the card through a means that is manned, |
| | automated, or a combination thereof. |
| 22 | The identity of the beneficiary is validated. For example |
| | the beneficiary may provide identification (ID), the GUID, a |
| | national ID or other valid identity document (e.g., passport), or |
| | the claim code to the distribution partner by verbally relaying the |
| | information to an agent or entering the information into a |
| | terminal that is communicatively connected to the host device |
| | 120. |
| 23 | If the beneficiary gives the validation data from step 22 |
| | above to the agent, the agent enters data into a computing device |
| | for delivery to the host device 120 to perform the validation; |
| | alternatively or in combination, the agent may conduct the |
| | validation at the facility by checking the data received in the step |
| | 22 above against a list or information stored in a database. |
| 24 | If a new beneficiary account is to be activated, |
| | information about the beneficiary may be collected such as: name |
| | of beneficiary, address of the beneficiary, validation of national |
| | identity, etc. Here, the agent or terminal may query the |
| | beneficiary for the information and, upon validation of the |
| | beneficiary, optionally produces a personalized card on site (e.g., |
| | the card may be embossed with cardholder's name flat printed |
| | with cardholder's name or other identifier) or issued without |
| | personalization. |
| 25 | The information about the beneficiary and the amount is |
| | submitted by the agent or terminal to the host device 120 to open |
| | the new beneficiary account in name of beneficiary. |
| 26 | The host device 120 facilitates intra-bank transfer and |
| | accounting entries to credit the beneficiary's account. |
| 27 | The host device 120 creates a linkage between the |
| | beneficiary and the beneficiary account; the host device 120 or |
| | beneficiary issuer device 124 may also facilitate creation of the |
| | card such as by facilitating the production of an embossing file |
| | sufficient to generate an encoded or personalized card |
| | corresponding to the underlying beneficiary account that has |
| | been opened for the beneficiary. |
| 28 | An encoded or personalized card associated with the |
| | beneficiary account is produced and given to the beneficiary. |
| | The card may, in turn, be used to draw funds from the underlying |
| | beneficiary account. |

### Exemplary Processes for a Plurality of Conditional Funds Transfer to a Master Account that Funds a New Beneficiary Account

In yet another implementation, the host facilitates the funds transfer from the provider account to a new beneficiary account using a Master Account that is identified by a Master Account Number, and can be associated with any number of currently existing or subsequently activated beneficiary accounts. Here, a first provider requests a funds transfer to a beneficiary. After the transfer condition(s) are satisfied, the beneficiary issuer opens the Master Account for the beneficiary. The Master Account may then be associated with currently existing or subsequently activated beneficiary accounts. In this manner, multiple requests to transfer funds from different providers, for example, to the beneficiary may be processed in the funds transfer system 100.

To illustrate, a first provider may utilize the provider device 116 to log onto a website hosted by the host device 120 to transfer funds to a beneficiary that does not have a beneficiary account or a Master Account established with the funds transfer system 100. The first provider may select an account of the first provider from which to withdraw funds (FIG. 4, user interface 400). The first provider may provide the host device 120 with information about the beneficiary, such as the name, a telephone number, an email address, or GUID of the beneficiary (FIG. 4, user interface 404) that can later be used to validate or identify the beneficiary. The first provider may also select the distribution partner or the location of the distribution partner (FIG. 4, user interface 404; FIG. 5, user interface 500) that will validate the beneficiary, facilitate the activation of the account or card, or distribute the card associated with the beneficiary account to the beneficiary.

The first provider may then make a funds transfer request. Here, the host computer 120 sends an authorization request to the first provider's issuer (e.g., the provider issuer device 122) and receives and authorization response back. If the transfer is authorized, the funds are eligible to be transferred to the designated account or held in escrow depending on whether the transfer conditions are satisfied.

In this example, an initial transfer condition may be to validate or authenticate the beneficiary prior to the funds being transferred out of escrow (or the provider account). For example, the beneficiary may provide the GUID to the distribution partner agent or enter the GUID into a terminal that is communicatively connected to the host device 120. As stated previously, the agent may locally validate the beneficiary, such as by checking the name of the beneficiary against a list of beneficiaries authorized to receive respective cards. Alternatively, or in combination, the validation may occur remotely from the distribution partner facility. Here, a transmission may include the GUID or other identifying data of the beneficiary that is then compared by the host device 120 or a third party and matched against identifiers of corresponding authorized beneficiaries. If a match is found, the beneficiary is authorized to activate the account and access the corresponding transferred funds.

Alternatively, or in combination, the initial condition may be that an identifier (e.g., name, phone number, or other GUID) of the first provider or the beneficiary, for example, is not included in a money laundering watch list. Here, an analysis can be conducted to determine if the initial money laundering transfer condition is satisfied. The host or a third party may compare the identifier(s) of the first provider or beneficiary against the money laundering watch list. If a match is not found, then the initial transfer condition is satisfied. In one implementation, the third party may be a government agency that conducts the validation or conducts one of the validations of the beneficiary. For example, the government agency may receive a transmission including the GUID or other identifying data of the beneficiary to match against a watch list (e.g., such as the money laundering watch list). If the beneficiary GUID matches data on the watch list, the government agency may notify the host device 120 to decline the funds transfer. Subsequently, the host device 120 may send a transmission to the distribution partner indicating that the beneficiary has been declined and access to the funds is denied. The decline may occur even if the host device 120 had previously validated the beneficiary.

If the funds transfer conditions are satisfied, the beneficiary receives a notification of the funds transfer from the first provider, such as by receiving an email or SMS notification that the money transfer is pending. The beneficiary may use the beneficiary device 118 to request activation of the Master Account and the new beneficiary account from the beneficiary issuer device 124, via the host device 120. The beneficiary issuer device 124 may activate the Master Account and the beneficiary account and submit a response to the activation request back to the beneficiary device 118.

The host device 120 may, in turn, transmit sufficient data to the beneficiary issuer device 124 for the beneficiary issuer to facilitate the distribution of a personalized card to the beneficiary. The beneficiary may facilitate the distribution of the personalized card by contacting the distribution partner to generate an encoded or personal card. To this end, the distribution partner may have a stock of blank cards or previously embossed cards. The distribution partner may have a terminal that is coupled to an embossing or printing machine. For example, the embossing or printing machine may prepare the card associated with the new beneficiary account by embossing or printing a number of the new beneficiary account or other information onto one of the cards in the stock. The terminal may then issue the card to the beneficiary. The Master Account can then be used for subsequent funds transfers to other beneficiary accounts (e.g., sub-method 300 of FIG. 3) that each may have a corresponding card. For example, a second provider may submit a funds transfer request to the host device 120. The host device 120 may process the funds transfer request as described in sub-methods 900 and 1000 of FIGS. 9 and 10, respectively. At step 1006 of sub-method 1000, the host device 120 determines that the funds are to be temporarily transferred to the existing Master Account, which may have been a Visa® debit account issued by the beneficiary issuer bank “Wells Fargo” created during the previous funds transfer. Also at step 1006, the host device 120 may determine that a new, second beneficiary account (e.g., MasterCard® DDA) is to be issued by a different beneficiary issuer (e.g., M&I bank) to effectuate the funds transfer from the second provider. Once the transfer conditions are satisfied at step 1008, the funds are transferred to the Master Account at the step 1010 and then transferred to the new, second beneficiary account. Therefore, in this example, the beneficiary may have two cards: one issued by the Wells Fargo bank having the funds provided by the first provider and a second card issued by the M&I bank having the funds provided by the second provider.

The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes. Based on the disclosure and teachings provided, a person of ordinary skill in the art will appreciate other ways or methods for various implementations. Moreover, it is understood that a functional step of described methods or processes, and combinations thereof can be implemented by computer program instructions that, when executed by a processor apparatus, create means for implementing the functional steps. The instructions may be included in computer readable medium that can be loaded onto a general purpose computer, a special purpose computer, or other programmable apparatus.

In certain implementations, instructions are encoded in computer readable medium wherein those instructions are executed by hardware to perform one or more of the steps of the flowcharts seen in FIGS. 2, 6, and 10. In yet other implementations, instructions reside in any other computer program product, where those instructions are executed by hardware external to, or internal to, other hardware to perform one or more of the steps of the flowcharts seen in FIGS. 2, 6, and 10. In either case the instructions, such as stored server readable code, may be encoded in a computer readable medium, or server readable medium, comprising, for example, a magnetic information storage medium, an optical information storage medium, an electronic information storage medium, and the like. “Electronic storage media,” may mean, for example and without limitation, one or more devices, such as and without limitation, a PROM, EPROM, EEPROM, Flash PROM, compactflash, smartmedia, and the like.

It is understood that the described examples and implementations are for illustrative purposes only and that various modifications or changes in light thereof will be suggested to persons skilled in the art and are to be included within the spirit and purview of this application and scope of the appended claims.

What is claimed is:

1. In a system that includes a host device processing a plurality of transactions for funds transfers between a funds provider and a funds beneficiary from a provider account issued to the funds provider by a provider issuer to a beneficiary account issued to a beneficiary by a beneficiary issuer, a method comprising a plurality of steps each being performed by software executed by a host computing device, wherein the steps include:
electronically receiving a funds transfer request to electronically transfer funds from the provider account to the beneficiary account;
electronically forming a first transmission including an authorization request to transfer funds from the funds provider account and electronically delivering the authorization request to the issuer of the provider account;
electronically receiving an authorization approval that is responsive to the authorization request;
electronically forming a second transmission including a transfer code uniquely associated with the funds transfer request for delivery to at least one of the provider issuer and the beneficiary issuer;
electronically receiving a load request including:
a request to load the beneficiary account with the funds; and
the transfer code;
electronically determining when a transfer condition is satisfied by at least electronically comparing the transfer code received in the load request with the transfer code in the second transmission; and
when the transfer condition is satisfied:
electronically forming a third transmission for delivery to the provider issuer, the third transmission including a remittance request to transfer the funds from the provider account; and
electronically forming a fourth transmission for delivery to the beneficiary issuer, the fourth transmission including data sufficient for the beneficiary issuer to facilitate the distribution of a personalized card corresponding to the beneficiary account to the beneficiary.

2. The method of claim 1, wherein the funds are selected from the group consisting of money, currency, tender, and loyalty points.

3. The method of claim 1, wherein electronically determining when the transfer condition is satisfied further includes comparing an identifier of the funds beneficiary against a money laundering watch list.

4. The method of claim 1, wherein:
the first transmission further includes data sufficient to suspend the funds from an available balance of the provider account; and
the method further comprise electronically forming a fifth transmission including a spring back request for delivery to the provider issuer to release the funds back into the available balance of the provider account when the transfer condition is not satisfied.

5. The method of claim 1, wherein:
the first transmission further includes data sufficient to transfer the funds from the provider account to a temporary account; and
the method further comprise electronically forming a fifth transmission including a spring back request for delivery to the provider issuer to transfer the funds from the temporary account back to the provider account when the transfer condition is not satisfied.

6. The method of claim 1, wherein:
the beneficiary account is a new account that is to be issued to the beneficiary by the beneficiary issuer; and
the fourth transmission includes data sufficient for the beneficiary issuer to issue the new account to the beneficiary.

7. The method of claim 1, wherein the transfer request includes:
an identifier associated with the provider account;
a value amount of the funds; and
an identifier for the funds beneficiary.

8. The method of claim 1, wherein determining when a transfer condition is satisfied further includes:
comparing a current currency exchange rate with a threshold currency exchange rate to find a match; and
comparing a current date to a predetermined expiration date.

9. The method of claim 1, wherein:
the steps further comprise electronically receiving a fifth transmission including data sufficient to authenticate the beneficiary account; and
determining when a transfer condition is satisfied further includes using the data in the fifth transmission to authenticate the beneficiary account.

10. The method of claim 9, wherein:
the first transmission includes information selected from the group consisting of: a telephone number of the beneficiary, an email address of the beneficiary, and a combination thereof; and
using the data received in the fifth transmission to authenticate the beneficiary includes electronically comparing the information in the first transmission with the data in the fifth transmission to find a match.

11. The method of claim 1, wherein:
prior to the transfer of funds to the beneficiary account, the funds are in a first currency of a first country; and
subsequent to the transfer of funds to the beneficiary account, the funds are in a second currency of a second country.

12. A non-transitory computer readable medium comprising instructions which, when executed by the host computing device, the host computing device performs the method as defined in claim 1.

13. A server apparatus comprising:
a processor apparatus communicatively connected with each of:
a user network including at least one computer; and
a transaction processing network including a provider issuer computing device (PICD) of an issuer associated with a provider account and a beneficiary issuer computing device (BICD);
and
a server readable medium including stored server readable code executable by the processor apparatus to:
form a first transmission, for delivery to the PICD via the transaction processing network, including an authorization request to suspend funds from an available balance of the provider account until the PICD receives a load request to transfer the funds to a beneficiary account of a beneficiary associated with a first identifier;
receive, via the transaction processing network, an authorization response responsive to said authorization request;
receive, via the at least one computer of the user network, a load request from the beneficiary including:
the load request; and
a second identifier of the beneficiary;
determine when a transfer condition is satisfied by authenticating the beneficiary in a comparison of the first identifier with the second identifier to find a match; and
when the transfer condition is satisfied by finding the match:
form a second transmission including the load request for delivery, via the transaction processing network, to the PICD; and
form a third transmission including a card generation request for delivery, via the transition processing network, to the BICD for the generation of a personalized card corresponding to the beneficiary account of the beneficiary.

14. The server apparatus as defined in claim 13, wherein the server readable medium includes stored server readable code further executable by the processor apparatus, when the transfer condition is not satisfied, to form a fourth transmission including a spring back request for delivery to the PICD to release the funds back to the available balance of the provider account.

15. The server apparatus as defined in claim 13, wherein the determining of when the transfer condition is satisfied further includes a comparison of a current currency exchange rate with a predetermined threshold currency exchange rate to find a match, whereby the transfer condition is satisfied at least by finding the matches of:
the first identifier with the second identifier; and
the current currency exchange rate with the predetermined threshold currency exchange rate.

16. The server apparatus as defined in claim 13, wherein the load request further includes an indicator of the beneficiary account selected from the group consisting of:
a banking account;
a prepaid account;
a reloadable account;
a gift account;
a credit account;
a debit account; and
a loyalty account.

17. The server apparatus as defined in claim 13, wherein the user network is the Internet.

18. A machine for remitting funds from a provider account to a prepaid account, the machine comprising:
means for receiving from a provider issuer of the provider account, an authorization approval for an amount of funds to be transferred from the provider account to the prepaid account of a beneficiary associated with a first code, wherein the prepaid account is to be activated and loaded in the future after receiving an activation request;
means for receiving an activation request requesting to activate the prepaid account;
means for facilitating the activation of the prepaid account;
means for receiving a load request from the beneficiary including a second code associated with the beneficiary;
means for determining when a transfer condition is satisfied including authenticating the beneficiary by comparing the first code with the second code to find a match; and
when the transfer condition is satisfied:
means for forming a load request for delivery to the provider issuer to transfer the funds from the provider account; and
means for forming a card generation request for delivery to a beneficiary issuer that issues the prepaid account to the beneficiary, to facilitate the generation of a personalized card corresponding to the prepaid account.

19. The machine as defined in claim 18, further comprising means for facilitating a suspension of the funds from an available balance of the provider account prior to said receipt of the load request, wherein the transfer of the funds is from the funds held in suspension in the provider account to the prepaid account.

20. The machine as defined in claim 18, wherein the means for determining when a transfer condition is satisfied further includes means for determining that a current date is before a predetermined expiration date for the transfer of the funds.

21. The machine as defined in claim 18, wherein:
prior to said transfer of funds, the funds are in a first currency of a first country; and
subsequent to said transfer of funds, the funds are in a second currency of a second country.
